(19) United States
(12) Patent Application Publication
(10) Pub. No.: US 2022/0172596 A1
(43) Pub. Date: Jun. 2, 2022

(54) USER TERMINAL FOR PROVIDING DISASTER INFORMATION, WEARABLE DEVICE CONNECTED TO THE USER TERMINAL, AND METHOD OF PROVIDING DISASTER INFORMATION

(71) Applicant: ELECTRONICS AND TELECOMMUNICATIONS RESEARCH INSTITUTE, Daejeon (KR)

(72) Inventors: Seung Hee OH, Daejeon (KR); Woo Sug JUNG, Daejeon (KR); Yong Tae LEE, Daejeon (KR)

(73) Assignee: ELECTRONICS AND TELECOMMUNICATIONS RESEARCH INSTITUTE, Daejeon (KR)

(21) Appl. No.: 17/531,686

(22) Filed: Nov. 19, 2021

(30) Foreign Application Priority Data
Nov. 27, 2020 (KR) 10-2020-0162520

(51) Int. Cl. G08B 21/10; G08B 25/01; G08B 3/10; H04W 4/90; H04W 4/14; H04W 76/50; H04L 51/046; G10L 13/08; G06F 1/16

(52) U.S. Cl. CPC G08B 21/10; G08B 25/016; G08B 3/10; H04W 4/90; G06F 1/163; H04W 76/50; H04L 51/046; G10L 13/08; H04W 4/14

(57) ABSTRACT

A wearable device for providing disaster information includes a communicator configured to receive, from a user terminal, a disaster information code obtained by coding a type of a disaster and a degree of risk of the disaster, a symbol and image generator configured to generate a symbol and an image corresponding to the disaster information code received through the communicator, and a display displaying the symbol and the image generated by the symbol and image generator.

### CROSS-REFERENCE TO RELATED APPLICATION

This application claims priority to and the benefit of Korean Patent Application No. 10-2020-0162520, filed on Nov. 27, 2020, the disclosure of which is incorporated herein by reference in its entirety.

### BACKGROUND

### 1. Field of the Invention

The present disclosure relates to a technique for providing disaster information to a user.

### 2. Discussion of Related Art

An emergency disaster text messaging service refers to a service that provides emergency disaster text messages informing of disasters such as typhoons, earthquakes, infectious disease, fine dust, forest fires, and large fires to a user terminal.

However, because emergency disaster text messages provided to users are limited to a native language of each country and contents thereof are limited to text, the emergency disaster text messages may not be available to users such as foreigners who are not familiar with the language of a corresponding country and disabled people (hereinafter referred to as “disaster vulnerable people”).

### SUMMARY OF THE INVENTION

To address the above-described problem, the present disclosure is directed to providing a wearable device and method for providing disaster information, which are capable of automatically mapping a type of disaster and a degree of risk of a disaster situation to a corresponding code from the disaster information delivered to a user terminal, transmitting the code to individual persons' wearable devices, and displaying the code in the form of image or symbol so that disaster vulnerable people may intuitively and quickly recognize the disaster situation.

The above-described aspects, other aspects, advantages and features of the present disclosure and methods of achieving them will be apparent from the following description of embodiments described below in detail in conjunction with the accompanying drawings.

According to an aspect of the present disclosure, a method of providing disaster information includes receiving, by a user terminal, an emergency disaster text message from a server, extracting, by the user terminal, disaster type information and disaster risk degree information from the received emergency disaster text message, generating, by the user terminal, a disaster information code on the basis of the disaster type information and the disaster risk degree information, transmitting, by the user terminal, the generated disaster information code to a wearable device,

displaying, by the wearable device, a symbol and an image corresponding to the disaster information code received from the user terminal, converting, by the user terminal, the received emergency disaster text message into an audio file, transmitting, by the user terminal, the audio file to an external audio output device, and playing the audio file by the external audio output device.

According to another aspect of the present disclosure, a user terminal for providing disaster information includes a first communicator configured to receive an emergency disaster text message from a server, an extractor configured to extract disaster type information and disaster risk degree information from the emergency disaster text message received from the first communicator, a code generator configured to generate a disaster information code on the basis of the disaster type information and the disaster risk degree information, a second communicator configured to transmit the disaster information code to a wearable device to allow the wearable device to display a symbol and an image corresponding to the disaster information code, a text-to-audio converter configured to convert the received emergency disaster text message into an audio file, and a third communicator configured to transmit the audio file to an external audio output device to allow the external audio output device to play the audio file.

According to another aspect of the present disclosure, a wearable device for providing disaster information includes a communicator configured to receive, from a user terminal, a disaster information code obtained by coding a type of a disaster and a degree of risk of the disaster, a symbol and image generator configured to generate a symbol and an image corresponding to the disaster information code received through the communicator, and a display displaying the symbol and the image generated by the symbol and image generator.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a diagram illustrating a configuration of an entire system for providing disaster information according to an embodiment of the present disclosure;

FIG. 2 is a block diagram illustrating an internal configuration of a user terminal of FIG. 1;

FIG. 3 is a block diagram illustrating an internal configuration of a wearable device of FIG. 1;

FIG. 4 is a diagram for describing an example of a data format of disaster information code generated by a code generator of FIG. 2; and

FIG. 5 is a flowchart of a method of providing disaster information according to an embodiment of the present disclosure.

### DETAILED DESCRIPTION OF EXEMPLARY EMBODIMENTS

A description of specific structures or functions of embodiments according to the concept of the present disclosure set forth herein is provided merely to describe the embodiments according to the concept of the present disclosure and thus embodiments according to the concept of the present disclosure may be implemented in various forms and are not limited the embodiments described herein.

Various modifications may be made in embodiments according to the concept of the present disclosure and these embodiments may be implemented in various forms and thus embodiments are illustrated in the drawings and described in detail in the present specification. However, embodiments according to the concept of the present disclosure are not limited to specific forms and should be understood to include modifications, equivalents, or alternatives included in the spirit and technical scope of the present disclosure.

The terms used herein are only used to describe certain embodiments and are not intended to limit the present disclosure. As used herein, the singular expressions are intended to include plural forms as well, unless the context clearly dictates otherwise. It should be understood that the terms “comprise” and/or “comprising”, when used herein, specify the presence of stated features, integers, steps, operations, elements, components, or a combination thereof, but do not preclude the presence or addition of one or more features, integers, steps, operations, elements, components, or a combination thereof.

The present disclosure relates to a method of transmitting disaster information to disaster vulnerable people in an emergency disaster situation.

According to the present disclosure, an emergency disaster text message, which has been only available in the native language and text of a corresponding country, is processed as disaster information in the form of an image, symbol, or voice and provided to a disaster vulnerable person through a wearable device (e.g., a smart watch or the like) or a Bluetooth earphone linked to the wearable device.

According to the present disclosure, upon receiving an emergency disaster text message, information about the type and degree of risk of a disaster may be extracted, the type of a currently connected wearable device may be identified, and disaster information may be transmitted again according to the type of the wearable device.

The disaster information may thus be intuitively recognizable by disaster vulnerable people and be supported to allow disaster vulnerable people to recognize a disaster situation quickly even when the identification of the emergency disaster text message is delayed.

Hereinafter, embodiments will be described in detail with reference to the accompanying drawings. However, the scope of the patent application is not limited or restricted to these embodiments. The same reference numerals shown in each drawing represent the same elements.

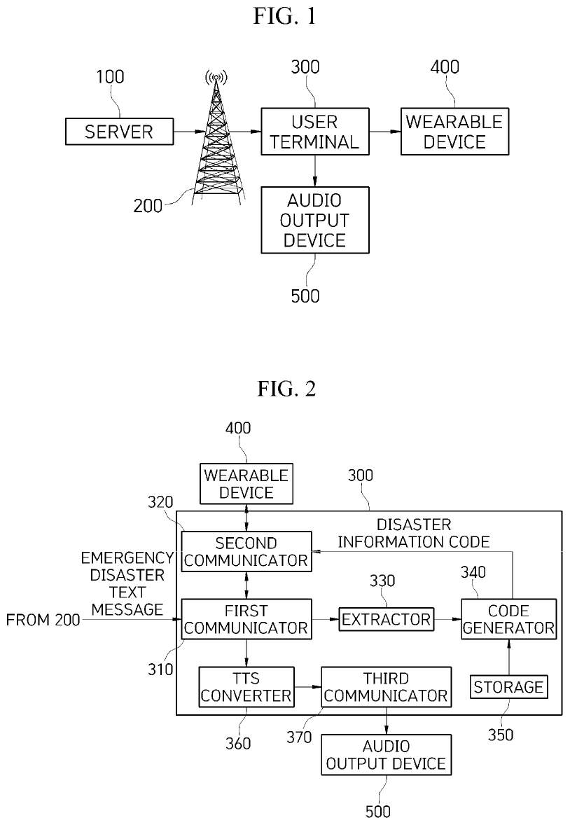

FIG. 1 is a diagram illustrating an entire configuration of a system for providing disaster information according to an embodiment of the present disclosure.

Referring to FIG. 1, the entire system according to an embodiment of the present disclosure includes a server 100, a base station 200, a user terminal 300, a wearable device 400, and an audio output device 500.

The server 100 is a server operated by a national institution, and transmits an emergency disaster text message, including information related to a disaster situation (disaster situation information), to the base station 200 installed in a specific region when the disaster situation has occurred in the specific region.

The disaster situation information may include, for example, information related to the type of disaster (hereinafter referred to as “disaster type information”) and information related to a degree of risk of disaster (hereinafter referred to as “disaster risk degree information”). The type of the disaster includes all types of disasters defined in a corresponding country, and the degree of risk of disaster includes three levels classified as a critical situation, emergency, and safety guidance defined according to the 3rd Generation Partnership Project (3GPP) standard and the Korean standard TTAK.KO-06.0263/R4.

The base station 200 broadcasts the emergency disaster text message transmitted from the server 100 to all user terminals 300 located in the coverage of the base station 200. For brevity's sake, FIG. 1 illustrates one user terminal 300.

The user terminal 300 extracts disaster type information and disaster risk degree information from the emergency disaster text message received from the server 100 through the base station 200 and combines the extracted disaster type information and disaster risk degree information. Here, the user terminal 300 may be, for example, a smart phone.

The user terminal 300 generates disaster information code mapped to the combination of the extracted disaster information and transmits the disaster information code to the wearable device 400.

In order to transmit the disaster information code to the wearable device 400, the user terminal 300 and the wearable device 400 may be configured to communicate through wired or wireless communication. In this case, the wireless communication may be, for example, short-range wireless communication such as Wi-Fi communication and Bluetooth communication.

The user terminal 300 converts the emergency disaster text message received from the server 100 through the base station 200 into an audio file and transmits the audio file to the audio output device 500 such as an earphone or a Bluetooth earphone connected to the user terminal 300 via wire or wirelessly.

The audio output device 500 plays the audio file received from the user terminal 300. Here, the audio output device 500 may be a speaker basically mounted in the user terminal 300.

FIG. 2 is a block diagram illustrating an internal configuration of the user terminal 300 of FIG. 1.

Referring to FIG. 2, the user terminal 300 includes a first communicator 310, a second communicator 320, an extractor 330, a code generator 340, a storage 350, a text-to-speech (TTS) converter 360, and a third communicator 370. Although not shown in FIG. 2, the user terminal 300 may further include a processor to control and manage operations of these components 310 to 370.

The first communicator 310 receives an emergency disaster text message from the server 100 through the base station 200 and inputs the emergency disaster text message to the extractor 330 and the TTS converter 360. To this end, the first communicator 310 may be configured to support mobile wireless communication, including 3G communication, 4G communication, 5G communication, and the like, and the present disclosure is not characterized by mobile wireless communication and thus a description of the mobile wireless communication will be replaced by the related art.

The second communicator 310 is a hardware configuration supporting a wired or wireless communication connection between the user terminal 300 and the wearable device 400, and automatically performs a connection process of checking whether the wearable device 400 (e.g., a smart watch or the like) is connected under control of the processor when an emergency disaster text message is received through the first communicator 310. Here, the connection process may include a device pairing process.

When a connection between the user terminal 300 and the wearable device 400 is completed through the second communicator 320, the extractor 330 analyzes the emergency disaster text message received through the first communicator 310 and extracts disaster type information and disaster risk degree information from the received emergency disaster text message.

The emergency disaster text message may be, for example, in a message format agreed upon in advance between the user terminal 300 and the server 100, and the extractor 330 may analyze (or parse) a header region of the message format to extract disaster type information and disaster risk degree information recorded on a payload region of the message format to be distinguished from each other.

The code generator 340 generates disaster information code corresponding to a result of combining the disaster type information and the disaster risk degree information received from the extractor 330. For example, the code generator 340 may generate disaster information code corresponding to a combination of the disaster type information and the disaster risk degree information using a mapping table stored in the storage 350. Here, the mapping table may be a table defining, in advance, mapping relations between combinations of multiple pieces of disaster type information and multiple pieces of disaster risk degree information and multiple disaster information codes. The storage 350 may be embodied as a volatile memory, a non-volatile memory, or a combination thereof.

The second communicator 320 transmits the disaster information code received from the code generator 340 to the wearable device 400 according to communication protocol agreed between the wearable device 400 and the user terminal 300.

The TTS converter 360 converts the emergency disaster text message input received through the first communicator 310 into an audio file using a TTS conversion algorithm (a text-to-audio conversion algorithm). The present disclosure is not characterized by the TTS conversion algorithm and thus a description thereof will be replaced by the related art.

The third communicator 370 is a hardware configuration that supports wired and/or wireless communication between the audio output device 500 and the user terminal 300 and transmits the audio file received from the TTS converter 360 to the audio output device 500.

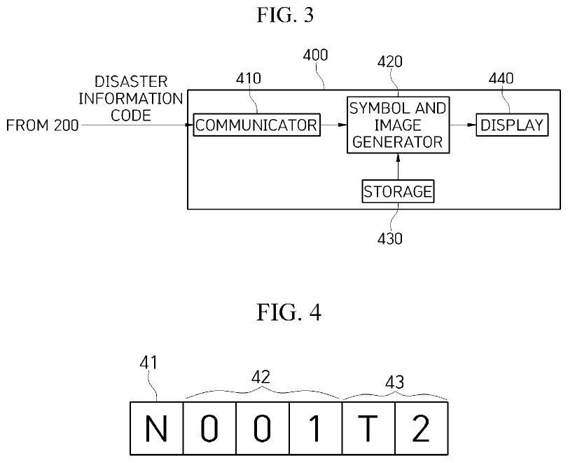

The audio output device 500 may be, for example, an earphone (or a headset) connected to the user terminal 300 via wire, a Bluetooth earphone (or a Bluetooth headset) wirelessly connected to the user terminal 300, or a speaker built into the user terminal 300. In this case, the third communicator 370 may be a component of an earphone jack or a headset jack, and when the audio output device 500 is a speaker built into the user terminal 300, the audio output device 500 shown as being located outside the user terminal 300 in FIG. 3 may be included in the user terminal 300.

When receiving the audio file from the user terminal 300 through the third communicator 370, the audio output device 500 plays the audio file. Therefore, a user is able to listen to a voice corresponding to the emergency disaster text message that is in the form of text.

The user terminal 300 may force an audio-related application to stop that is being currently played to play the audio file received from the TTS converter 360.

FIG. 3 is a block diagram illustrating an internal configuration of the wearable device 400 of FIG. 1.

Referring to FIG. 3, the wearable device 400 includes, for example, a communicator 410, a symbol and image generator 420, a storage 430, and a display 440. Although not shown in FIG. 3, the wearable device 400 may further include a processor to control and manage operations of the above components 410 to 440.

The communicator 410 receives disaster information code from the user terminal 300 and inputs the disaster information code to the symbol and image generator 420.

The symbol and image generator 420 generates a symbol and an image to be mapped (correspond) to the disaster information code input from the communicator 410.

The storage 430 stores various types of symbols and images classified according to multiple disaster information codes, and the symbol and image generator 420 searches the storage 430 for various symbols and images using the disaster information code input thereto through the communicator 410. When the symbol and the image mapped to the disaster information code received from the user terminal 300 are searched for, the searched-for symbol and the image are loaded from the storage 430. Thereafter, the symbol and image generator 420 transmits the symbol and the image loaded from the storage 430 to the display 440.

The display 440 displays the symbol and the image transmitted from the symbol and image generator 420.

As described above, the wearable device 400 displays an emergency disaster text message, which is provided from the server 100, in the form of visual information such as symbols and images so that disaster vulnerable people such as children, foreigners, and disabled persons may intuitively recognize disaster situations.

FIG. 4 is a diagram for describing an example of a data format of disaster information code generated by the code generator 340 of FIG. 2.

Referring to FIG. 4, the disaster information code includes a first identification code 41 for identification of a disaster type as a large category item, a second identification code 42 for identification of a disaster type as small category items, and a third identification code 43 for identification of degrees of risk of disasters classified by the first and second identification codes 41 and 42.

The first identification code 41 may be marked with an alphabet capital letter. When the types of disaster are largely classified as a “natural disaster” and a “societal disaster”, the first identification code 41 may be marked as “N” which is a capital letter of the first letter of “natural disaster” when a disaster type is the natural disaster and may be marked as “S” which is a capital letter of the first letter of “societal disaster: when a disaster type is the societal disaster.

The second identification code 42 may be marked with three numbers. Table 1 below shows an example of the second identification code 42.

TABLE 1

| sub-classification | unique number |
|---|---|
| typhoon | 001 |
| localized heavy rain | 002 |
| strong wind | 003 |
| landslide | 004 |
| collapse of steep hill | 005 |
| great fire | 101 |
| fine dust | 102 |

The third identification code 43 is a code representing a degree of risk of a disaster and may be marked with a combination of an alphabet capital letter and a number. For example, a critical situation may be marked as “T1”, emergency may be marked as “T2”, and safety guidance may be marked as “T3”. Thus, the disaster information code “N001T2” shown in FIG. 4 is a code of an emergency disaster text message that represents a “typhoon corresponding to an emergency”.

Degrees of risk of disasters identified by the third identification code 43 are classified into three levels, i.e., a critical situation, emergency, and safety guidance defined in the 3GPP standard and the Korean standard TTAK.KO-06.0263/R4 but will be classified into more than three levels through an amendment to the standards in the near future.

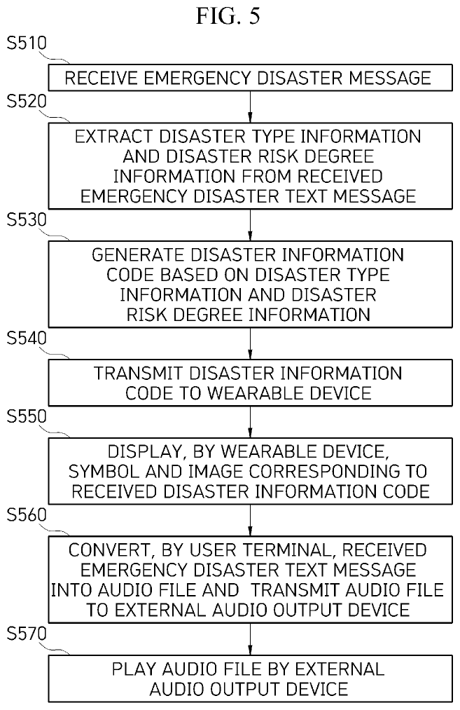

FIG. 5 is a flowchart of a method of providing disaster information according to an embodiment of the present disclosure.

Referring to FIG. 5, in S510, the user terminal 300 receives an emergency disaster message from the server 100.

Next, in S520, the user terminal 300 extracts disaster type information and disaster risk degree information from the received emergency disaster text message.

In an embodiment, in S520, a header region of the emergency disaster text message may be analyzed to extract disaster type information and disaster risk degree information recorded on a payload region of the emergency disaster text message.

Next, in S530, the user terminal 300 generates a disaster information code on the basis of the disaster type information and the disaster risk degree information.

In an embodiment, S530 may include combining the disaster type information and the disaster risk degree information and generating a disaster information code mapped to a combination of the disaster type information and the disaster risk degree information. Here, the disaster information code mapped to the combination of the disaster type information and the disaster risk degree information may be generated using a mapping table stored in advance. The mapping table may be a table defining, in advance, mapping relations between combinations of multiple pieces of disaster type information and multiple pieces of disaster risk degree information and multiple disaster information codes.

Next, in S540, the user terminal 300 transmits the generated disaster information code to the wearable device 400. Here, the wearable device 400 may be, for example, a smart watch.

Next, in S550, the wearable device 400 displays a symbol and an image corresponding to the disaster information code received from the user terminal 300.

In an embodiment, S550 includes receiving a disaster information code from the user terminal 300, generating the symbol and the image mapped to the disaster information code received from the user terminal by searching a storage storing multiple symbols and images classified according to multiple disaster information codes, and displaying the generated symbol and the image through a display included in the wearable device 400.

Thereafter, in S560, the user terminal 300 converts the received emergency disaster text message into an audio file and transmits the audio file to the external audio output device 500. Here, the audio output device 500 may be, for example, an earphone, a headphone, a Bluetooth earphone, a Bluetooth headset, or the like. To convert the emergency disaster text message into the audio file, for example, a text-to-audio conversion algorithm may be used.

Next, in S570, the external audio output device 500 plays the audio file.

According to the present disclosure, a type of a disaster and a degree of risk of a disaster situation can be automatically mapped to a corresponding code, the code may be transmitted to and displayed in the form of image or symbol on wearable devices of individual persons so that people may be quickly informed of the disaster situation even when aspects of disasters are becoming complicated, larger, and globalized, and people's levels of satisfaction and reliability of disaster notification services may be enhanced.

In the method of providing disaster information described above, examples of a computer-readable medium may include a magnetic medium such as a hard disc, a floppy disk, and a magnetic tape, an optical recording medium such as a CD-ROM and a DVD, a magneto-optical medium such as a floptical disk, and a hardware device specially configured to store and execute program instructions, such as a ROM, a RAM, and a flash memory.

Examples of the program instructions include not only machine language code created by a compiler but also high-level language code executable by a computer using an interpreter or the like. A hardware device as described above may be configured to operate as one or more software modules to perform operations of the present disclosure and vice versa.

The scope of the present disclosure to be protected is not limited to the embodiments explicitly described above. Furthermore, the present disclosure is not limited to modifications or alternatives that are obvious in the technical field to which the present disclosure pertains.

What is claimed is:

1. A method of providing disaster information, comprising:
receiving, by a user terminal, an emergency disaster text message from a server;
extracting, by the user terminal, disaster type information and disaster risk degree information from the received emergency disaster text message;
generating, by the user terminal, a disaster information code on the basis of the disaster type information and the disaster risk degree information;
transmitting, by the user terminal, the generated disaster information code to a wearable device;
displaying, by the wearable device, a symbol and an image corresponding to the disaster information code received from the user terminal;
converting, by the user terminal, the received emergency disaster text message into an audio file;
transmitting, by the user terminal, the audio file to an external audio output device; and
playing the audio file by the external audio output device.

2. The method of claim 1, wherein the extracting of the disaster type information and the disaster risk degree information comprises analyzing a head region of the emergency disaster text message and extracting disaster type information and disaster risk degree information recorded on a payload region of the emergency disaster text message.

3. The method of claim 1, wherein the generating of the disaster information code comprises:
combining the disaster type information and the disaster risk degree information; and
generating the disaster information code mapped to a combination of the disaster type information and the disaster risk degree information.

4. The method of claim 3, wherein the generating of the disaster information code mapped to the combination of the disaster type information and the disaster risk degree information comprises generating the disaster information code mapped to the combination of the disaster type information and the disaster risk degree information using a mapping table stored in advance.

5. The method of claim 4, wherein the mapping table comprises a table defining, in advance, a mapping relationship between combinations of multiple pieces of disaster type information and multiple pieces of disaster risk degree information and multiple disaster information codes.

6. The method of claim 1, wherein the displaying of the symbol and the image comprises:
receiving the disaster information code from the user terminal;
generating the symbol and image mapped to the disaster information code received from the user terminal by searching a storage storing multiple symbols and images classified according to multiple disaster information codes; and
displaying the generated symbol and image through a display included in the wearable device.

7. The method of claim 1, wherein the converting of the received emergency disaster text message into the audio file comprises converting the emergency disaster text message into the audio file using a text-to-audio conversion algorithm.

8. A user terminal for providing disaster information, comprising:
a first communicator configured to receive an emergency disaster text message from a server;
an extractor configured to extract disaster type information and disaster risk degree information from the emergency disaster text message received from the first communicator;
a code generator configured to generate a disaster information code on the basis of the disaster type information and the disaster risk degree information;
a second communicator configured to transmit the disaster information code to a wearable device to allow the wearable device to display a symbol and an image corresponding to the disaster information code;
a text-to-audio converter configured to convert the received emergency disaster text message into an audio file; and
a third communicator configured to transmit the audio file to an external audio output device to allow the external audio output device to play the audio file.

9. The user terminal of claim 8, further comprising a storage storing a mapping table defining, in advance, a mapping relationship between combinations of multiple pieces of disaster type information and multiple pieces of disaster risk degree information and multiple disaster information codes,
wherein the code generator generates the disaster information code mapped to a combination of the disaster type information and the disaster risk degree information using the mapping table.

10. The user terminal of claim 8, wherein the code generator generates the disaster information code to include a first identification code for identification of a type of a disaster as a large category item, a second identification code for identification of the type of the disaster as small category items, and a third identification code for identification of a degree of risk of the disaster classified by the first and second identification codes.

11. A wearable device for providing disaster information, comprising:
a communicator configured to receive, from a user terminal, a disaster information code obtained by coding a type of a disaster and a degree of risk of the disaster;
a symbol and image generator configured to generate a symbol and an image corresponding to the disaster information code received through the communicator; and
a display displaying the symbol and the image generated by the symbol and image generator.

12. The wearable device of claim 11, wherein the disaster information code comprises a first identification code for identification of a type of a disaster as a large category item, a second identification code for identification of the type of the disaster as small category items, and a third identification code for identification of a degree of risk of the disaster classified by the first and second identification codes.

13. The wearable device of claim 11, further comprising a storage configured to store multiple symbols and images classified according to multiple disaster information codes, and
wherein the symbol and image generator generates the symbol and the image mapped to the disaster information code received through the communicator by searching the storage.
